(19) United States
(12) Patent Application Publication
(10) Pub. No.: US 2014/0334854 A1
(43) Pub. Date: Nov. 13, 2014

(54) DEVELOPING DEVICE AND IMAGE FORMING APPARATUS

(71) Applicant: CANON KABUSHIKI KAISHA, Tokyo (JP)

(72) Inventors: Takuya Kitamura, Yokohama-shi (JP); Motoki Adachi, Ashigarakami-gun (JP); Hideo Kihara, Yokohama-shi (JP); Kouki Yano, Kawasaki-shi (JP); Yuta Isobe, Kawasaki-shi (JP)

(73) Assignee: CANON KABUSHIKI KAISHA, Tokyo (JP)

(21) Appl. No.: 14/273,589

(22) Filed: May 9, 2014

(30) Foreign Application Priority Data
May 10, 2013 (JP) 2013-100151
Apr. 8, 2014 (JP) 2014-079697

(51) Int. Cl. G03G 15/08

(52) U.S. Cl. CPC G03G 15/0812
USPC 399/281

(57) ABSTRACT

A developing apparatus for developing operation on an image bearing member, includes a rotatable developer carrying member for carrying a developer; a rubbing member for rubbing the developer carrying member with the developer therebetween to cause the developer to be carried on the developer carrying member; wherein the rubbing member includes a free end portion extending toward a downstream with respect to a rotational moving direction of the developer carrying member, the free end portion rubs the developer carrying member, and wherein the rubbing member is provided with a reinforcing portion for reinforcing the free end portion.

### FIELD OF THE INVENTION AND RELATED ART

The present invention relates to image forming apparatuses, such as copying machine, printers, etc., which are provided with a function for forming an image on a sheet of recording medium. In particular it relates to a developing device and a process cartridge with which these image forming apparatuses are provided.

It has been known that some conventional developing devices are configured as follows: They are made up of a development roller, a supply roller, a regulating member, a toner container and so on. The development roller bears developer, and develops an electrostatic latent image formed on a photosensitive member. The regulating member regulates in thickness the layer of developer on the development roller. The toner container stores toner (Japanese Laid-open Patent Application H06-301281).

The supply roller is placed in contact with the development roller in such a manner that it is compressed by a preset amount by the development roller. It rotates in the same direction as the development roller. Conventionally, a sponge roller made up of a metallic core, and a layer of sponge which covers the peripheral surface of the metallic core is used as the supply roller. In a case where a sponge roller is used as the supply roller, developer is taken up by the sponge layer of the sponge roller, and is conveyed to the area of contact, between the development roller and sponge roller, in which the sponge layer of the sponge roller is compressed by the development roller. Consequently, the developer in the sponge layer is discharged, being thereby supplied to the development roller.

In recent years, users of an image forming apparatus have become increasingly concerned with the environment. Thus, it has become important to use the developer in a toner container as completely as possible. However, there has been a concern that in the case of the conventional configuration for a developing device, the developer in the portion of the sponge layer which is in the adjacencies of the metallic core of the sponge roller will fail to be discharged from the sponge layer to be supplied to the development roller. In order to reduce the sponge roller in the amount by which the developer fails to be delivered from the development roller to be used for development, it is necessary not to use the sponge roller to supply the development roller with developer.

The present invention was made in consideration of an issue such as the above-described one. Thus, the primary object of the present invention is to increase a developer supply roller in the ratio with which the developer in the roller can be discharged to be used for development.

### SUMMARY OF THE INVENTION

According to an aspect of the present invention, there is provided a developing apparatus for developing operation on an image bearing member, comprising a rotatable developer carrying member for carrying a developer; a rubbing member for rubbing said developer carrying member with the developer therebetween to cause the developer to be carried on said developer carrying member; wherein said rubbing member includes a free end portion extending toward a downstream with respect to a rotational moving direction of said developer carrying member, said free end portion rubs said developer carrying member, and wherein said rubbing member is provided with a reinforcing portion for reinforcing the free end portion.

Further features of the present invention will become apparent from the following description of exemplary embodiments (with reference to the attached drawings).

### BRIEF DESCRIPTION OF THE DRAWINGS

FIG. 1 is a schematic sectional view of the developing device in the first embodiment of the present invention. It is for describing the structure of the developing device.

FIG. 2 is a schematic sectional view of the image forming apparatus in the first embodiment.

FIG. 3 is a schematic sectional view of the image forming apparatus in the first embodiment.

FIG. 4 is a schematic drawing for describing the toner movement in the adjacencies of the nip between the toner supplying member and development roller, in the first embodiment.

FIG. 5 is a schematic drawing for showing the toner movement in the nip between the toner supplying member and development roller, in a case where a wedge-shaped portion is present.

FIG. 6 is a schematic sectional view of the developing device in the second embodiment of the present invention, and is for describing the structure of the developing device.

FIG. 7 is a schematic sectional view of the developing device in the third embodiment of the present invention, and is for describing the structure of the developing device.

FIG. 8 is a schematic drawing for describing the toner movement in the adjacencies of the nip between the toner supplying member and development roller.

FIG. 9 is a schematic drawing for describing the toner movement in the adjacencies of the nip between the toner supplying member and development roller, in the third embodiment, in a case where the angle θ is an acute angle.

FIG. 10 is a schematic drawing of a combination of the toner supplying member and development roller in one of the modifications of the preceding embodiment, and is for describing the configuration of the developing device.

FIG. 11 is a schematic drawing of a combination of the toner supplying member and development roller in another modification of the preceding embodiments, and is for showing the configuration of the developing device.

### DESCRIPTION OF THE PREFERRED EMBODIMENTS

Hereinafter, a few of the preferred embodiments of the present invention are described with reference to the appended drawings. However, the measurements, materials, and shapes of the structural components of the developing device, and the positional relationship among the structural components, in the following embodiments of the present invention, are not intended to limit the present invention in these properties. That is, they are to be modified as necessary according to the configuration of the device to which the present invention is applied, and also, according to the condition under which the device is used. The present invention relates to a developing apparatus employed by an electrophotographic apparatus, an electrostatic recording apparatus, and the like to develop an electrostatic latent image (into visible image), with the use of developer.

### Embodiment 1

Next, the first embodiment of the present invention is described.

### <Image Forming Apparatus>

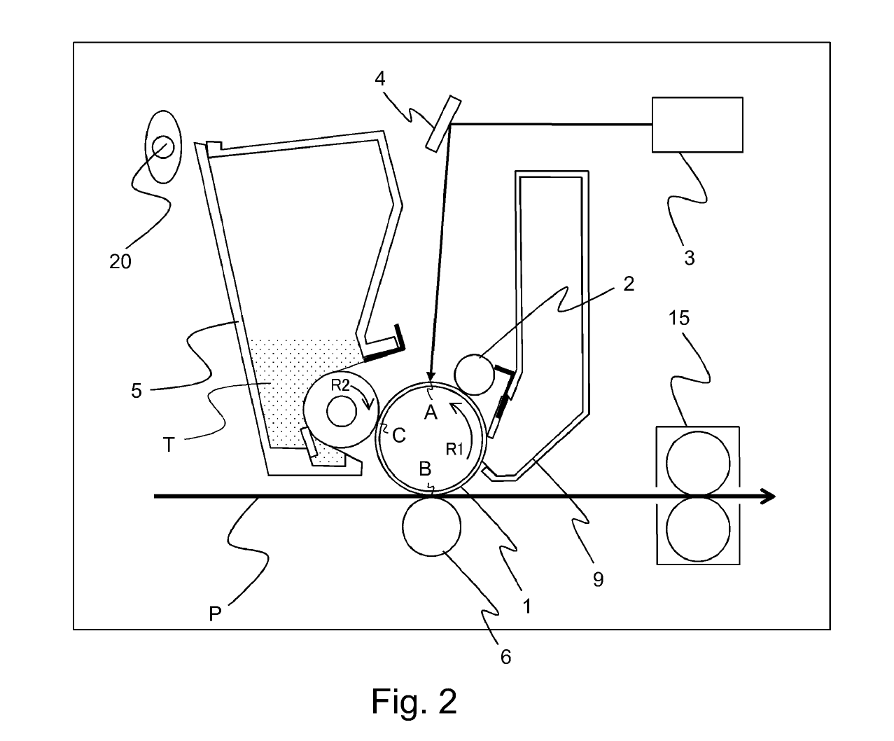

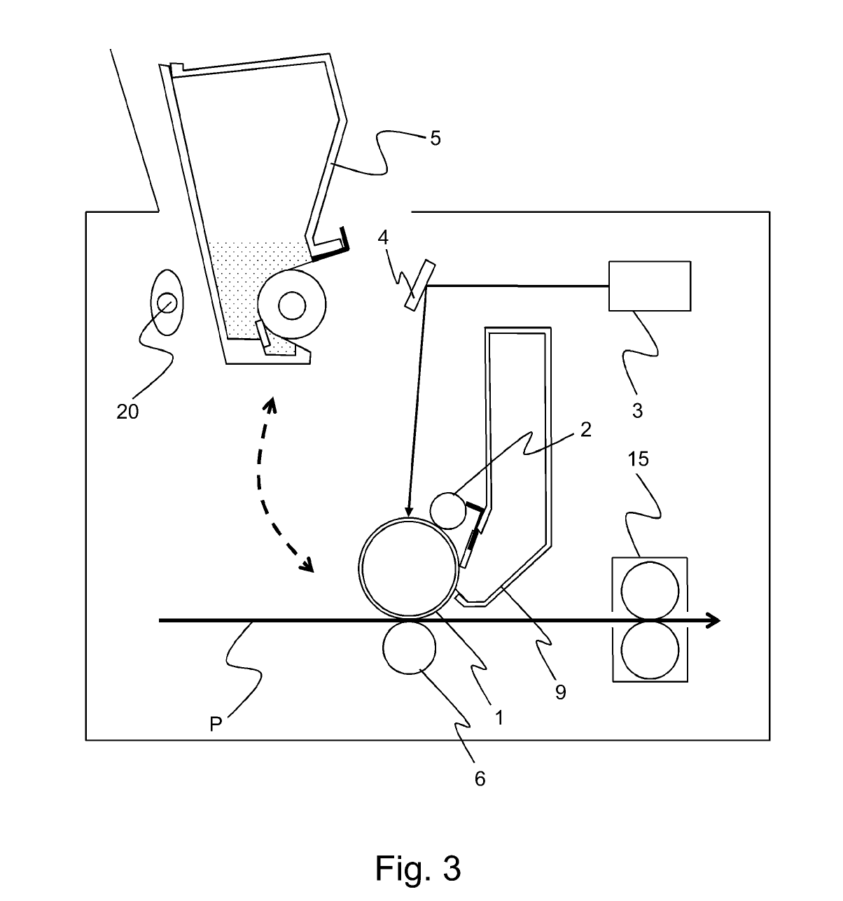

FIGS. 2 and 3 are schematic sectional views of the image forming apparatus in this embodiment, at a plane perpendicular to the rotational axis of the photosensitive drum 1 (development roller 25). Referring to FIG. 2, the image forming apparatus is provided with a photosensitive drum 1, as an image bearing member, which is rotatable in the direction indicated by an arrow mark R1. The image forming apparatus is also provided with a charge roller 2, a developing device (development unit) 5, a transfer roller 6, and a cleaning device 9, which are disposed in the listed order in terms of the direction indicated by the arrow mark R1 in FIG. 2. Further, the image forming apparatus is provided with an exposing device 3, which forms an electrostatic latent image on the peripheral surface of the photosensitive drum 1 by emitting a beam of laser light in such a manner that the beam is projected upon points of exposure (which are on downstream side of charge roller 2 and upstream side of developing device 5) on the photosensitive drum 1, by way of a deflection mirror 4.

With the image forming apparatus being structured as described above, as the photosensitive drum 1 is rotated, the charging, exposing, developing, and cleaning processes are sequentially carried out for numerous points of the peripheral surface of the photosensitive drum 1 (detailed description of these processes is given later).

The charge roller 2 is for uniformly charging the peripheral surface of the photosensitive drum 1. The developing device 5 is for storing non-magnetic single-component toner T, and developing an electrostatic latent image formed on the peripheral surface of the photosensitive drum 1 (puts photosensitive drum 1 through development process), into a toner image (visible image formed of toner).

Referring to FIG. 3, the developing device 5 is structured so that it can be removably installable in the main assembly of the image forming apparatus. That is, the developing device 5 may be placed in a cartridge which is removably mountable in the main assembly of the image forming apparatus. The transfer roller 6 is for transferring a toner image formed on the peripheral surface of the photosensitive drum 1, onto a sheet P of recording medium. The cleaning device 9 is for removing the toner which failed to be transferred onto a sheet P of recording medium, being therefore remaining on the photosensitive drum 1 after the transfer. It is provided with a cleaning blade, which is placed in contact with the peripheral surface of the photosensitive drum 1 to scrape away the toner from the peripheral surface of the photosensitive drum 1.

Further, the image forming apparatus is provided with a fixing device 15 which applies heat and pressure to the sheet P of recording medium and the toner image thereon to fix the toner image to the sheet P, after the transfer of the toner image onto the sheet P.

### <Image Forming Process>

Next, the image forming operation of the image forming apparatus in this embodiment is described.

First, referring to FIG. 2, the photosensitive drum 1 is rotated in the direction indicated by an arrow mark R1 at 100 mm/sec. As the photosensitive drum 1 is rotated, the peripheral surface of the photosensitive drum 1 is charged by the charge roller 2 to a preset potential level. Then, a beam of laser light is emitted by the exposing device 3, while being modulated with image formation signals which correspond to color components of the image to be formed, so that the beam of laser light is projected upon the points of the photosensitive drum 1, which correspond to the exposing position A of the image forming apparatus. Consequently, an electrostatic image is effected upon the peripheral surface of the photosensitive drum 1. The electrostatic latent image formed on the peripheral surface of the photosensitive drum 1 is developed by the developing device 5 in the development position C shown in FIG. 2. Consequently, a toner image is formed on the peripheral surface of the photosensitive drum 1. The toner image formed on the photosensitive drum 1 is transferred onto a sheet P of recording medium, by the transfer roller 6, in the transfer position B shown in FIG. 2. After the transfer of the toner image onto the sheet P, the sheet P is sent to the fixing device 15, in which the sheet P and the toner image thereon are subjected to heat and pressure. Consequently, the toner image on the sheet P becomes fixed to the sheet P. This is how an image is formed on the sheet P.

### <Developing Device>

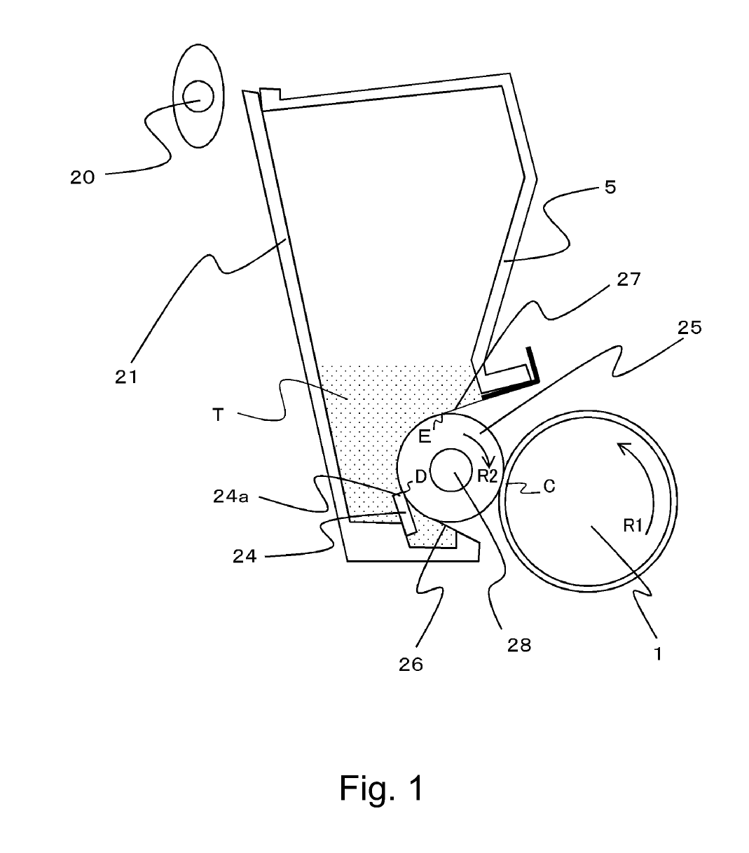

FIG. 1 is a schematic sectional view of the developing device 5 in this embodiment. It is for describing the structure of the developing device 5. Hereafter, the developing device 5 in this embodiment is described in detail.

The developing device 5 is provided with a development roller 25 which is a developer bearing member, a regulation blade 27 which is a regulating member, and a toner supplying member 24 as a toner rubbing member. The developer container 21 is for storing toner. It is equivalent to a toner storage. The development roller 25 is for bearing toner T. It is positioned so that it faces the opening of the developer container 21, which is at the bottom of the developer container 21. The regulation blade 27 is for controlling the amount, per unit area, by which toner is allowed to remain on the peripheral surface of the development roller 25, that is, for controlling in thickness the layer of toner on the peripheral surface of the development roller 25. The toner supplying member 24 is positioned so that it contacts the peripheral surface of the development roller 25. The toner supplying member 24 is described later.

By being structured as described above, the developing device 5 supplies the peripheral surface of the photosensitive drum 1 with the toner in the layer of toner borne by the development roller 25 while being regulated in thickness by the regulation blade 27.

During a developing operation, the development roller 25 rotates in contact with the photosensitive drum 1. After the completion of the developing operation, a cam 20 with which the main assembly of the image forming apparatus is provided is rotated. As the cam 20 is rotated, it presses the top portion of the developer container 21, causing thereby the development roller 25 to be separated from the photosensitive drum 1. After the separation of the development roller 25 from the photosensitive drum 1, the controlling means of the main assembly of the image forming apparatus stops the rotation of the development roller 25. The development roller 25 comprises: an electrically conductive metallic core 28, which is 8 mm in diameter; and an electrically conductive elastic layer formed of rubber, around the metallic core 28; and a surface layer formed of acrylic rubber, urethane rubber, or the like, in a manner to cover the elastic layer. The development roller 25 is 13 mm in external diameter, and roughly 10⁵ Ω·cm in volume resistivity. The development roller 25 is supported by the developer container 21 so that during a developing operation, it contacts the photosensitive drum 1 in a development position C, and can be rotationally driven in the direction indicated by the arrow mark R2 shown in FIG. 1. During a developing operation, the development roller 25 is 160 mm/sec in peripheral velocity.

The regulation blade 27 is made of a flexible sheet of stainless steel (SUS). It is attached to a supporting plate, by one of its long edge portions, in such a manner that its free long edge portion (other long edge portion) remains in contact with the peripheral surface of the development roller 25. The supporting plate is fixed to the developer container 21. The regulation blade 27 is disposed in such an attitude that its long edge portion by which it is held to the supporting plate is on the downstream side of its unattached (free) long edge portion which is in contact with the peripheral surface of the development roller 25, in terms of the rotational direction (indicated by arrow mark R2), and also, that the flat and smooth surface portion of the adjacencies of the unattached (free) edge portion rubs the peripheral surface of the development roller 25, in the toner amount regulation portion, that is, an area where the toner layer on the peripheral surface of the development roller 25 is regulated in the amount per unit area. In addition, the developing device 5 is provided with a leakage prevention seal 26, which keeps sealed the gap between the development roller 25 and developer container 21.

The toner supplying member 24, which is one of the structural components of the developing device 5 that characterize this embodiment is a flexible sheet made of polyphenylene sulfide. It is 0.25 mm in thickness. It is fixed to the developer container 21 by one of its long edge portions in such an attitude that the other long edge portion 24a (which hereafter may be referred to as “free long edge portion 24a”) is on the downstream side of the base portion of the toner supplying member 24, in terms of the rotational direction of the development roller 25. In this embodiment, it is positioned so that its free long edge portion is on the downstream side of its base portion in terms of the rotational direction of the development roller 25.

The developing device 5 is structured so that the portion of the toner supplying member 24, which includes the free long edge 24c, and the portion 24b which is next to the long edge 24c, contacts the peripheral surface of the development roller 25, with the presence of toner between the toner supplying member 24 and the peripheral surface of the development roller 25, in the toner supply position D (which hereafter may be referred to simply as “nip D”). With the developing device 25 being structured as described above, as the development roller 25 rotates the development roller 25 and toner supplying member 24 rub against each other in the nip D, with presence of toner between them. Further, the developing device 5 is structured so that the top surface of the body of toner in the developer container 21 will be above the level of the nip D. That is, the developer container 21 is structured so that the toner in the developer container 21 will be in the portion of the developer container 21, which includes the area in which the development roller 25 and toner supplying member 24 rub against each other.

### <Development Process>

The toner stored in the developer container 21 is supplied by the toner supplying member 24 to the development roller 25, in the nip D, so that the toner adheres to the peripheral surface of the development roller 25. Then, the toner particles having adhered to the peripheral surface of the development roller 25 are conveyed by the rotation of the development roller 25 to the toner amount regulation position E, shown in FIG. 1, in which it is regulated by the regulation blade 27 so that the amount of toner per unit area of the peripheral surface of the development roller 25 becomes proper. Then, the toner particles coated on the peripheral surface of the development roller 25 are used in the development position D to develop (into visible image) the electrostatic latent image formed on the peripheral surface of the photosensitive drum 1. The toner particles which were not used for development, and therefore, are remaining on the peripheral surface of the development roller 25 are returned to the developer container 21.

### <Toner Supply Process>

Next, the method for supplying the development roller 25 with toner, with use of the toner supplying member 24, is described. In order to supply the development roller 25 with toner, it is necessary to place electrically charged toner in contact with the development roller 25. Thus, the developing device 5 in this embodiment is structured so that the toner supplying member 24 and development roller 25 rub against each other, with the presence of charged toner between the toner supply roller 24 and development roller 25, in the nip D. Thus, toner particles are tumbled in the nip D, whereby they are given triboelectric charge. After being given triboelectric charge, the toner particles are adhered to the peripheral surface of the development roller 25 by the mutual attraction between the toner particles and photosensitive drum 25. That is, the toner particles are borne on the peripheral surface of the development roller 25. In other words, in order to ensure that the development roller 25 is reliably supplied with toner, it has to be ensured that toner is always present in the nip D between the toner supplying member 24 and development roller 25.

The inventors of the present invention discovered that it can be ensured by structuring the developing device 5 so that the “free long edge” of the toner supplying member 24 is placed in contact with the development roller 25, that toner will be between the toner supplying member 24 and development roller 25, in the nip D.

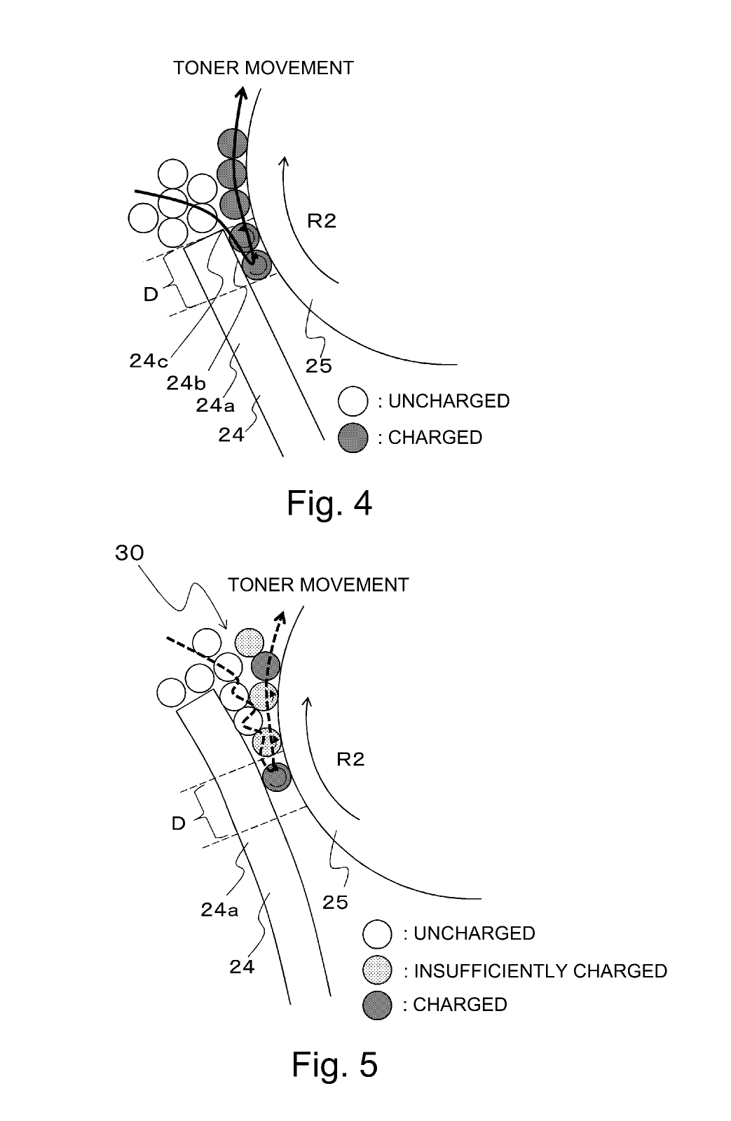

FIG. 4 is a drawing for describing the toner movement which occurs in the adjacencies of the nip D in a case where the free long edge portion 24a of the toner supplying member 24, and the portion 24b of the toner supplying member 24, which is next to the free long edge 34c of the toner supplying member 24, are kept in contact with each other (they are made to rub against each other). It is assumed here that the top surface of the body of toner (in developer container (top surface) is positioned higher than the level of the nip D.

Toner particles which are free of electrical charge are not subjected to external electrical force, and therefore, can freely move. Therefore, in a case where the developing device 5 is structured so that the toner supplying member 24 contacts the development roller 25 by its portion 24b which is next to its free long edge 24c, toner particles which are free of electrical charge instantly flow into the nip D. Then, as the development roller 25 is rotated, the toner particles are frictionally charged because of the presence of the internal pressure of the nip N. Then, they are conveyed further by the development roller 25. As a certain amount of toner (toner particles) is conveyed out of the nip D by the development roller 25, other toner particles which are also free of electrical charge flow into the nip D in a manner to fill the void created as the charged toner particles are moved out the nip D.

That is, the development roller 25 is supplied with toner through the repetition of the above described cycle of toner particle movement.

FIG. 5 is a drawing for describing the toner movement which occurs in the developer container 21, in a case where the developing device 5 is structured so that a space 30 which is wedge-shaped in cross-section is present in the developer container 21, on the downstream side of the nip D between the toner supplying member 24 and development roller 25, in terms of the rotational direction of the development roller 25.

With the presence of the space 30 (which hereafter will be referred to as “wedge-shaped space 30”), a toner pool is created on the front side of the nip D (downstream side of nip D in terms of rotational direction of development roller 25). The presence of the toner pool will possibly prevent toner from flowing into the nip D.

That is, in a case where the wedge-shaped space 30 is present, it is possible that the toner will be prevented from flowing into the nip D, being thereby prevented from reaching the nip D. Thus, it is possible that it will become impossible for the development roller 25 to be reliably supplied with toner. Even in a case where the wedge-shaped space 30 is present, the toner particles having flowed into the nip D are given a satisfactory amount of electrical charge. In the toner pool, however, it does not occur that toner particles are satisfactorily charged by friction. The toner particles which failed to be fully charged, fail to be conveyed by the development roller 25, and therefore, become stagnant in the wedge-shaped space 30.

As described above, in a case where a wedge-shape space such as the one shown in FIG. 5 is present in the developing device 5, it is possible that toner will not reliably flow into the nip D, and therefore, the development roller 25 will not be reliably supplied with toner.

As will be evident from the description of this embodiment given above, by structuring the developing device 5 so that the portion 24b of the toner supplying member 24, which is next to the free long edge 24c of the toner supplying member 24, is placed in contact with the development roller 25, it is possible to supply the development roller 25 with toner, without employing a toner supply roller with which conventional developing devices are provided to supply the development roller 25 with toner, and which is provided with a sponge layer. Further, the developing device 5 in this embodiment is structured so that it does not require a sponge roller, and therefore, it does not suffer from the problem that the toner in the sponge layer cannot be moved out of the sponge layer, and therefore, remains in the sponge layer, being therefore unusable. Therefore, the developing device 5 in this embodiment can more effectively use the toner in its developer container than any developing device in accordance with the prior art. Further, the developing device 5 does not require a toner supply roller, and therefore, is less in cost than any developing device in accordance with the prior art. In other words, the present invention can provide a developing device which is less in cost than any developing device in accordance with the prior art. Further, the developing device 5 in this embodiment does not require a toner supply roller, and therefore, it is smaller than any developing device in accordance with the prior art. That is, the present invention can provide a developing device which is smaller in size than any developing device in accordance with the prior art.

In this embodiment, the toner supplying member 24 was made of polyphenylene sulfide. However, this embodiment is not intended to limit the present invention in terms of the material for the toner supplying member 24. That is, the present invention is also applicable to a developing device, the toner supplying member 24 of which is made of polyester, polyethylene terephthalate, or the like resin. Further, this embodiment is not intended to limit the present invention in terms of the thickness of the toner supplying member 24. All that is required of a developing device in order for the device to be compatible with the present invention is that the developing device is not structured so that as the toner supplying member 24 is placed in contact with the development roller 25, the “wedge-shaped space” in which toner will become stagnant is created between the toner supplying member 24 and development roller 25.

Further, the developing device 5 in this embodiment used non-magnetic single-component developer. However, this embodiment is not intended to limit the present invention in terms of developer choice. All that is required of developer in order for the developer to be compatible with the present invention is that as the portion 24b of the toner supplying member 24, which is next to the free long edge 24c of the toner supplying member 24, and the development roller 25 rub against each other, with the presence of the developer between the toner supplying member 24 and development roller 25, the developer is borne by the development roller 25.

Further, in this embodiment, the image forming apparatus is structured so that the developing device 5 is removably installable into the main assembly of the image forming apparatus. This embodiment, however, is not intended to limit the present invention in terms of the structure of an image forming apparatus. For example, the present invention is also applicable to an image forming apparatus structured so that its developing device (5) and photosensitive drum (1) are integral parts of the process cartridge 10 which is removably installable in the main assembly of the image forming apparatus. Further, the present invention is also compatible with a process cartridge which comprises an integral combination of the developing device (5) and photosensitive drum (1), and at least one of a charge roller (2) and a cleaning device (9) which are means for processing the photosensitive drum (1). Further, the present invention is also applicable to an image forming apparatus structured so that its developing device (5) is fixed to the main assembly of the image forming apparatus, being therefore not installed into, or removed from, the main assembly by a user.

### Embodiment 2

Next, the second embodiment of the present invention is described.

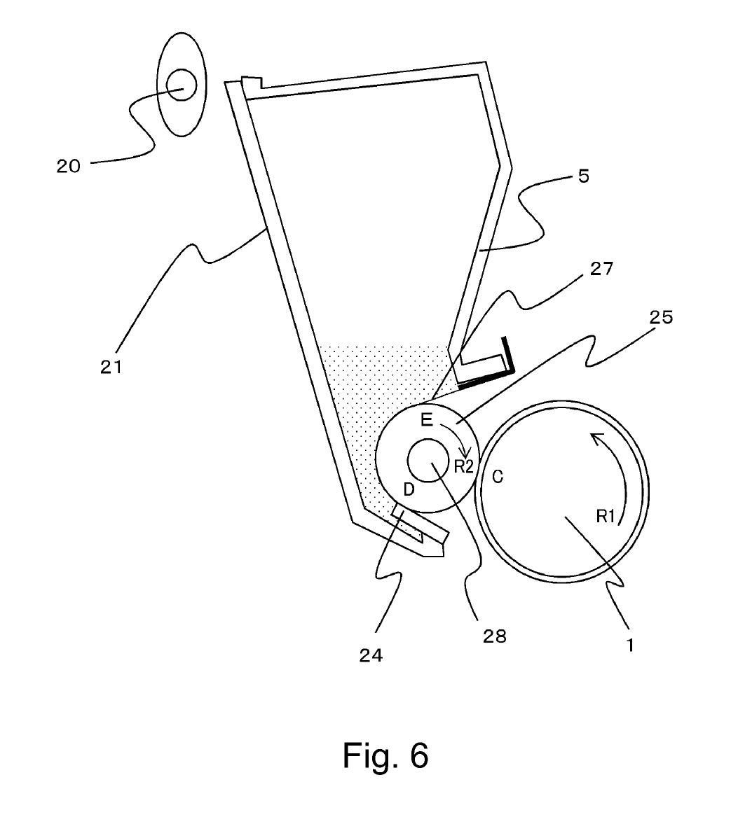

FIG. 6 is a schematic sectional view of the image forming apparatus in this embodiment. It shows the general structure of the apparatus. In the following description of this embodiment, only the structural components of the apparatus, which are different from the counterparts in the first embodiment, will be described. That is, the structural components of the image forming apparatus in this embodiment, which are similar to the counterparts in the first embodiment, will not be described.

One of the characteristic features of this embodiment is that the toner supplying member 24 doubles as the toner leak prevention seal 26 which covers the gap between the development roller 25 and developer container 21.

In the case of an image forming apparatus structured like the image forming apparatus in the first embodiment, it is unlikely for the area between the toner supplying member 24 and leak prevention seal 26 to be used to supply the development roller 25 with toner. Thus, from the standpoint of using the toner in the developer container 21 as thoroughly as possible, the developing device is desired to be structured so that this area between the toner supplying member 24 and leak prevention seal 26 becomes as small as possible.

In this embodiment, therefore, the developing device 5 is structured so that the toner supplying member 24 doubles as a leakage prevention seal to eliminate the above described area. Therefore, the developing device in this embodiment is greater in the ratio by which the developer in the developer container 21 can be actually used for development, than any developing device in accordance with the prior art. Further, because the toner supplying member 24 doubles as the leakage prevention seal, the leakage prevention seal is unnecessary. Thus, the developing device in this embodiment is smaller in size and component count than any developing device in accordance with the prior art. That is, the present invention can reduce a developing device in size and component count.

### Embodiment 3

Next, the third embodiment of the present invention is described.

This embodiment is different from the above described first and second embodiments in the shape (structure) of the toner supplying member 24. In the following description of this embodiment, a case in which the toner supplying member 24 in this embodiment is used in place of the toner supplying member 24 in the first embodiment is described. The toner supplying member 24 in this embodiment is also satisfactorily usable in place of the toner supplying member 24 in the second embodiment. In the following description of this embodiment, only the structural components of the developing device in this embodiment, which are different from the counterparts in the first and second embodiments will be described. That is, the structural components of the developing device in this embodiment, which are similar to the counterparts in the first and second embodiments will not be described.

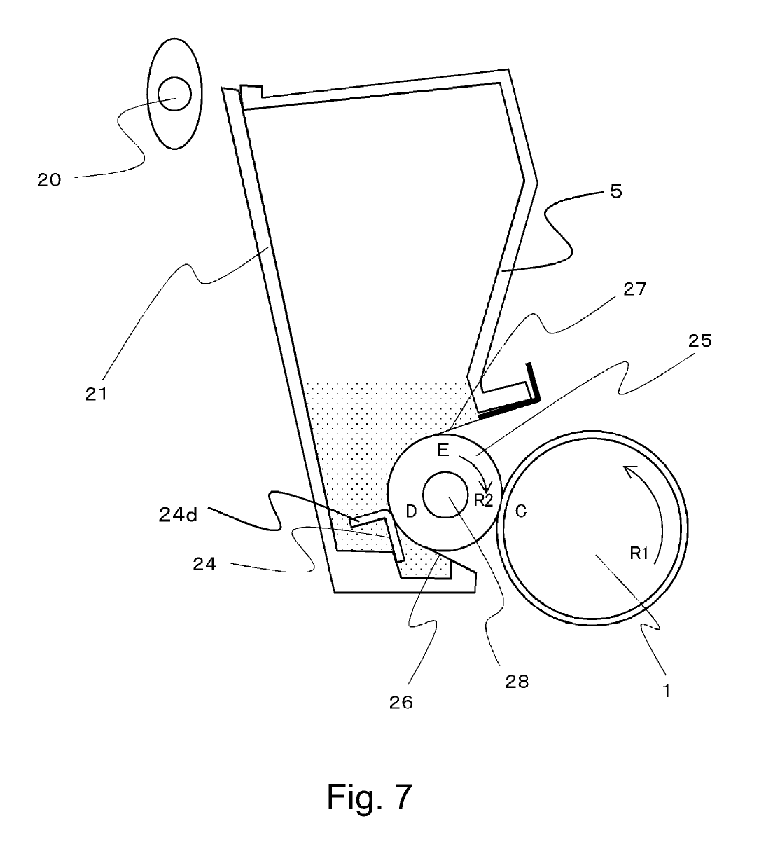

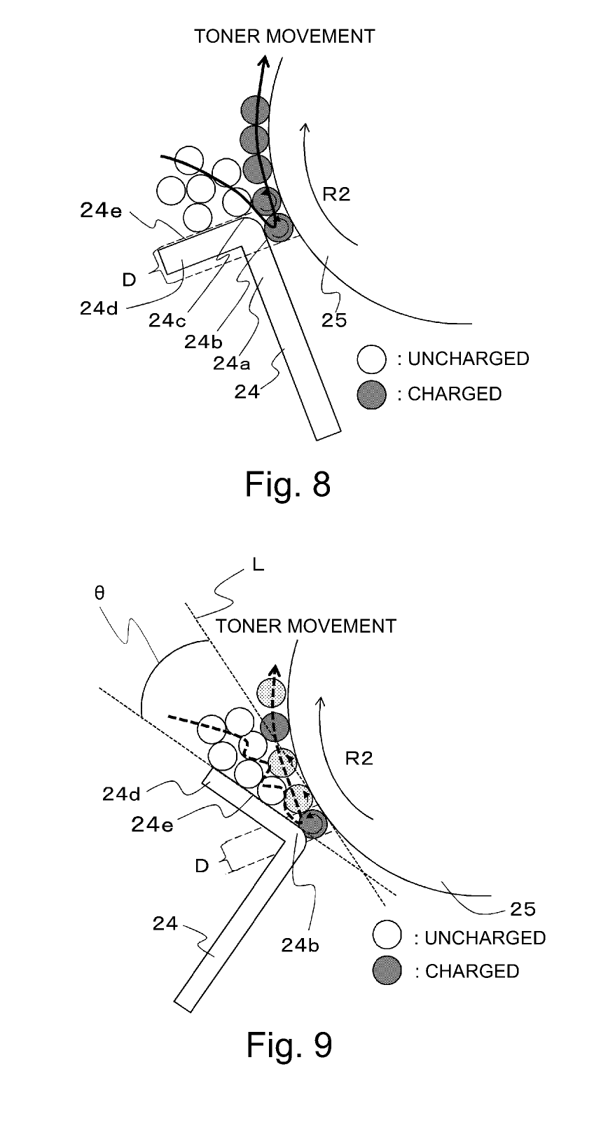

FIG. 7 is a schematic sectional view of the developing device in this embodiment. It is for describing the structure of the developing device. FIG. 8 is a drawing for describing the toner movement which occurs in the adjacencies of the nip D, in this embodiment.

A toner supply member such as the one described above is made of a thin sheet of a certain substance. Thus, it is possible that as the toner supply member is adhered to the developer container 21, it becomes wavy.

As the toner supply member becomes wavy, the nip F between the development roller 25 and toner supplying member 24 becomes nonuniform in internal pressure, which possibly makes some toner particles fail to be frictionally charged. The toner particles having failed to be charged are unlikely to be borne by the development roller 25. It is possible, therefore, that, in terms of the lengthwise direction of the development roller 25 (direction parallel to axial line of development roller 25), some portions of the development roller 25 will be supplied with toner, whereas the other portions will not be supplied with toner. In other words, it is possible that the development roller 25 will become nonuniform in terms of its lengthwise direction, in the amount of toner per unit area on its peripheral surface. Therefore, it is possible that the developing device 5 will non-uniformly develop an electrostatic latent image.

In this embodiment, therefore, in order to prevent the portion 24b of the toner supplying member 24, which is next to the free long edge 24c of the toner supplying member 24, from becoming wavy, the toner supplying member 24 is provided with a portion 24d, as a portion for reinforcing the portion 24b, which is perpendicularly extended from the free long edge 24c of the toner supplying member 24 in the opposite direction from the development roller 25.

With the provision of the toner supplying member 24 with the reinforcement portion 24d, it is possible to increase the toner supplying member 24 in stiffness. Therefore, it is possible to prevent the problem that when the toner supplying member 24 is adhered to the developer container 21, toner supplying member 24, in particular, the long edge portion 24b of the toner supplying member 24, becomes wavy.

Next, the relationship between the reinforcement portion 24d of the toner supplying member 24 and the development roller 25 is described.

FIG. 9 is a drawing for describing the toner movement which occurs in the developer container 21 in a case where an angle θ is acute. The angle θ is the angle between the surface 24e of the reinforcement portion 24d of the toner supplying member 24, which is on the downstream side of the toner supplying member 24 in terms of the rotational direction of the development roller 25, and a line L which is tangential to the development roller 25 at the point of contact between the free long edge portion 24b (in particular, free long edge 24c) of the toner supplying member 24, and the development roller 25.

In the case where the angle θ is acute, it is possible that a toner pool such as the one in the first embodiment will be created between the surface 24e of the reinforcement portion 24d of the toner supplying member 24, and the development roller 25. The presence of the developer pool will possibly prevent toner from reliably flowing into the nip D, as described above. Therefore, it is possible for the development roller 25 not to be reliably supplied with toner.

Therefore, in order to make the developing device 5 in this embodiment as effective as those in the first and second embodiments (toner supplying member 24 is positioned so that it contacts development roller 25 by its portion 24b which is next to free long edge 24c), it is desired that the developing device 5 is structured so that the angle θ becomes no less than 90 degrees (right or obtuse angle).

As described above, according to this embodiment, the portion 24b of the free long edge portion 24a of the toner supplying member 24 is provided with the reinforcement portion 24d in order to increase the toner supplying member 24 in stiffness. Therefore, not only is this embodiment as effective as the first and second embodiments, but also, it offers the following effect. That is, this embodiment can prevent the problem that when the toner supplying member 24 is adhered to the developer container 21, the toner supplying member 24 becomes wavy. Therefore, the development roller 25 is reliably supplied with toner.

Also in this embodiment, the reinforcement portion 24d was attached, as the toner supply member reinforcing member, to the toner supplying member 24. This embodiment, however, is not intended to limit the present invention in terms of the choice of the toner supplying member reinforcing component. That is, the present invention is compatible with any reinforcing component for a toner supplying member, as long as the reinforcing component can prevent the portion 24b of the free long edge portion 24a of the toner supply member 25 from becoming wavy. Further, this embodiment is not intended to limit the present invention in terms of where on the toner supply member 25 the reinforcement portion 24d is to be attached. That is, the present invention is also compatible with a reinforcement portion 24d which is not attached to the portion 24b of the free long edge portion 24a of the toner supplying member 24, as long as the reinforcement portion 24d can prevent the toner supplying member 24 from becoming wavy.

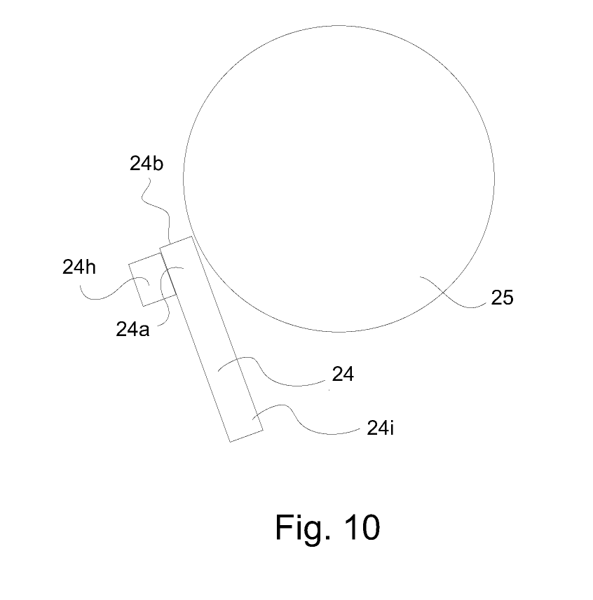

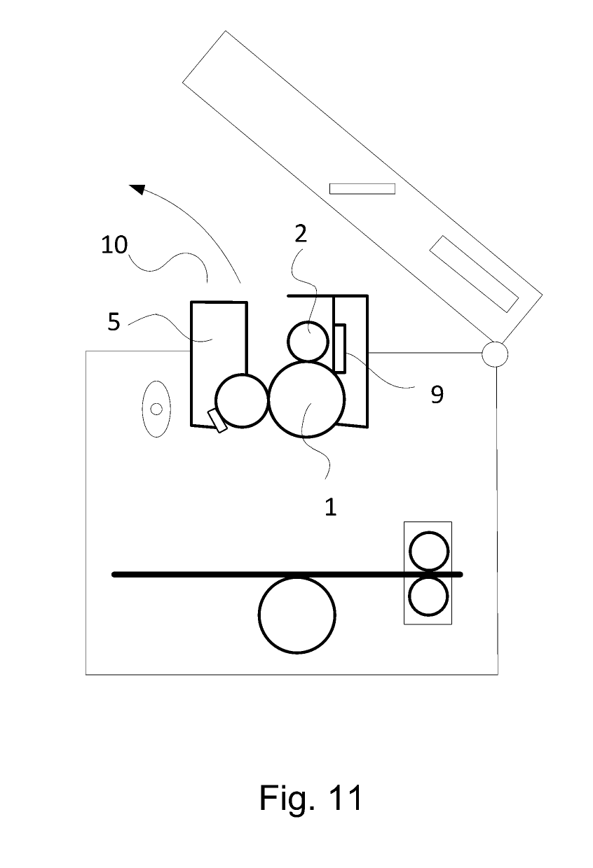

Next, referring to FIG. 10, the reinforcement portion 24d in this modified version of the this embodiment is described. In this modified version of this embodiment, the reinforcement portion 24h is fixed (adhered) to the free long edge portion 24a of the toner supplying member 24. More specifically, the reinforcement portion 24h is on the opposite side of the toner supplying member 24 from the development roller 25. That is, the reinforcement portion 24h is fixed to the opposite surface of the toner supplying member 24 from the development roller contacting surface of the toner supplying member 24. The reinforcement portion 24h in this modified version of the third embodiment is the same in thickness and material as that in the third embodiment. This modification of the third embodiment is not intended to limit the present invention in terms of the dimension and material for the toner supplying member 24.

The reinforcement portion 24h was placed on the free long edge portion 24a of the toner supplying member 24. Therefore, the thickness of the reinforced portion of the toner supplying member 24 is thicker than (twice as thick as) the base portion 24i of the toner supplying member 24. That is, the reinforced portion (24h) is the portion of the toner supplying member 24, which is thicker than the base portion 24i of the toner supplying member 24.

With the provision of the reinforcement portion 24h, the free long edge portion 24a of the toner supplying member 24 is greater in stiffness, and therefore, is less likely to deform (less likely to become wavy).

The following is the summary of the effects of the above described embodiments of the present invention disclosed in this patent application.

That is, according to the developing device configurations disclosed in this patent application, the present invention can provide a developing device which can use a greater amount of toner in the device than any developing device in accordance with the prior art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Applications Nos. 100151/2013 and 079697/2014 filed May 10, 2013 and Apr. 8, 2014, respectively, which are hereby incorporated by reference.

What is claimed is:

1. A developing apparatus for developing operation on an image bearing member, comprising:
a rotatable developer carrying member for carrying a developer;
a rubbing member for rubbing said developer carrying member with the developer therebetween to cause the developer to be carried on said developer carrying member;
wherein said rubbing member includes a free end portion extending toward a downstream with respect to a rotational moving direction of said developer carrying member, said free end portion rubs said developer carrying member, and
wherein said rubbing member is provided with a reinforcing portion for reinforcing the free end portion.

2. An apparatus according to claim 1, wherein said reinforcing portion extends from the free end portion away from said developer carrying member.

3. An apparatus according to claim 2, wherein said reinforcing portion is provided by bending said free end portion.

4. An apparatus according to claim 2, wherein in a plane perpendicular to a rotational axis of said developer carrying member, an angle formed between a downstream side surface of said reinforcing portion and a tangent line of said developer carrying member at the free end portion of said rubbing member is not less than 90 degrees.

5. An apparatus according to claim 1, wherein said reinforcing portion is provided in a side remote from said developer carrying member.

6. An apparatus according to claim 1, wherein said reinforcing portion is provided by thickening the free end portion.

7. An apparatus according to claim 1, wherein said rubbing member includes a flexible sheet.

8. An apparatus according to claim 1, further comprising a developer accommodating portion for accommodating the developer in a region including a rubbing contact portion between said developer carrying member and said rubbing member.

9. An apparatus according to claim 8, wherein said rubbing member functions as a sealing member for sealing a gap between said developer accommodating portion and said developer carrying member.

10. An apparatus according to claim 1, wherein said developer is a non-magnetic one-component developer.

11. An apparatus according to claim 1, wherein said developing apparatus is detachably mountable relative to a main assembly of an image forming apparatus.

12. An apparatus according to claim 11, wherein said developing apparatus is detachably mountable to a main assembly of an image forming apparatus as a part of a process cartridge including the image bearing member.

13. An image forming apparatus comprising:
an image bearing member;
a developing apparatus for developing operation on said image bearing member;
said developing apparatus including,
a rotatable developer carrying member for carrying a developer;
a rubbing member for rubbing said developer carrying member with the developer therebetween to cause the developer to be carried on said developer carrying member;
wherein said rubbing member includes a free end portion extending toward a downstream with respect to a rotational moving direction of said developer carrying member,
wherein said free end portion rubs said developer carrying member,
wherein said rubbing member is provided with a reinforcing portion for reinforcing the free end portion.

14. An apparatus according to claim 13, wherein said reinforcing portion extends from the free end portion away from said developer carrying member.

15. An apparatus according to claim 14, wherein said reinforcing portion is provided by bending said free end portion.

16. An apparatus according to claim 14, wherein in a plane perpendicular to a rotational axis of said developer carrying member, an angle formed between a downstream side surface of said reinforcing portion and a tangent line of said developer carrying member at the free end portion of said rubbing member is not less than 90 degrees.

17. An apparatus according to claim 13, wherein said reinforcing portion is provided in a side remote from said developer carrying member.

18. An apparatus according to claim 13, wherein said reinforcing portion is provided by thickening the free end portion.

19. An apparatus according to claim 13, wherein said rubbing member includes a flexible sheet.

20. An apparatus according to claim 13, wherein further comprising a developer accommodating portion for accommodating the developer in a region including a rubbing contact portion between said developer carrying member and said rubbing member.
